(19) United States
(12) Patent Application Publication
(10) Pub. No.: US 2005/0202921 A1
(43) Pub. Date: Sep. 15, 2005

(54) APPLICATION OF NOVEL SURFACE FINISHING TECHNIQUE FOR IMPROVING REAR AXLE EFFICIENCY

(75) Inventors: Arup Gangopadhyay, Novi, MI (US); Jagadish Sorab, West Bloomfield, MI (US); Michael Schroder, Northville, MI (US); Sam Asaro, Whitmore Lake, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 10/708,508

(22) Filed: Mar. 9, 2004

(51) Int. Cl. F16H 48/06

(52) U.S. Cl. 475/230

(57) ABSTRACT

A super-finished rear axle gear set for a vehicle is provided for improving rear axle efficiency. The rear axle gear set includes a ring gear and a pinion gear. The super-finish is applied to at least the ring gear teeth and pinion gear teeth. The super-finish causes the teeth to be smoother, thus decreasing the coefficient of friction between the teeth when the pinion gear teeth drive the ring gear.

### BACKGROUND OF INVENTION

1. Field of the Invention

The present invention relates to a super-finished rear axle gear set for a vehicle that improves the fuel efficiency of the vehicle.

2. Background Art

In an effort to improve fuel efficiency for a vehicle lubricants are used to reduce the amount of friction between the ring and pinion gears in the rear axle gear set. Using appropriate lubricants to reduce friction in a gear set is crucial because the gears operate differently under different conditions. Depending on the speed and load of the vehicle, there can be full metal to metal contact, partial metal to metal contact or the metal surfaces may be completely separated by the lubricant. A manufacturer is forced to choose one type of lubricant to minimize the friction in three different scenarios because it is impractical to use three different types of lubricant for each of the regimes. This leads to a decreased rear axle efficiency because the performance of the selected lubricant is not optimal for each scenario.

### SUMMARY OF INVENTION

According to one aspect of the present invention, the rear axle gear set for a vehicle is super-finished in order to improve the rear axle efficiency by reducing the severity of metal to metal contact. The super-finish makes the gears smoother, thereby reducing the friction when there is full metal to metal contact or partial metal to metal contact.

The rear axle gear set includes a pinion gear and a ring gear. The pinion gear is connected to the drive shaft of the vehicle. The ring gear is connected to the rear axle of the vehicle and has teeth that mesh with the teeth on the pinion gear. When the gear set is in operation, the teeth of the pinion gear drive the teeth of the ring gear. The teeth of the pinion and ring gears are super-finished to reduce the friction between the teeth of the pinion gear and the teeth of the ring gear when the gear set is in operation.

The super-finish is applied to the gears by first placing the gears into a vessel containing an acidic solution and ceramic pebbles of various sizes. The acidic solution etches high asperities from the surfaces of the gears, leaving a chemical film. The ceramic pebbles remove the film, leaving a smooth, super-finished surface. The final step is putting the gears into a vessel containing a solution to neutralize the acid. After the gears have been super-finished, they have a mirror-finish. After super-finishing, the pinion gear and ring gear have an average surface roughness of 4-7 microinches.

These and other aspects of the present invention will be apparent to one of ordinary skill in the art in view of the attached detailed description of the preferred embodiments below.

### BRIEF DESCRIPTION OF DRAWINGS

FIG. 1 is a perspective view of a rear axle gear set.

FIG. 2 is a side view of the rear axle gear set.

FIG. 3 is a flowchart of the process used to apply a super-finish to the rear axle gear set.

FIG. 4 is a schematic view of the test fixture used to test rear axle gear set efficiency.

FIGS. 5a-c are a set of graphs showing the difference in efficiency between a production and a super-finished rear axle gear set.

FIGS. 6a-c are a set of graphs showing the difference in temperature between a production and a super-finished rear axle gear set.

FIG. 7 is a graph showing the difference in fuel efficiency between a production and a super-finished rear axle gear set.

### DETAILED DESCRIPTION

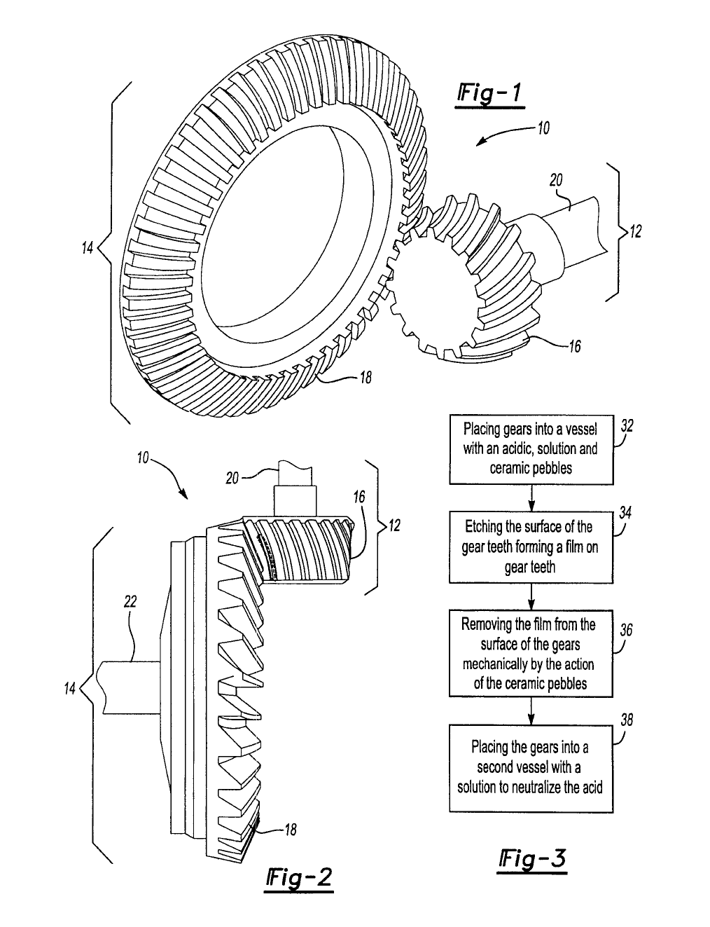

Referring now to FIGS. 1 and 2, a rear axle gear set 10 is illustrated. The gear set 10 includes a pinion gear 12 and a ring gear 14. The pinion gear 12 is connected to the drive shaft of the vehicle 20. The pinion has a plurality of gear teeth 16. The ring gear 14 is connected to the rear axle of the vehicle 20, and has teeth 18 that mesh with the pinion gear teeth 16. The pinion gear teeth 16 engage the ring gear teeth 18 to drive the ring gear 14.

A super-finish is applied to the pinion gear teeth 16 and the ring gear teeth 18 to reduce the friction between the pinion gear teeth 16 and the ring gear teeth 18.

Referring now to FIG. 3, a flowchart is shown detailing the method of applying the super-finish to the pinion gear teeth 18 and the ring gear teeth 16. The first step 32 is to put the pinion gear 12 and the ring gear 14 into a slowly rotating vessel containing an acidic solution and ceramic pebbles of varying sizes. In the second step 34, the acidic solution etches out high asperities and leaves a chemical film on the pinion gear 12 and on the ring gear 14. In the third step 36, the ceramic pebbles remove the chemical film from the pinion gear 12 and the ring gear 14. In the final step 38, the pinion gear 12 and the ring gear 14 are put into a second slowly rotating vessel containing ceramic pebbles and a solution to neutralize the acid. The purpose of the ceramic pebbles is to remove any of the film that may be left from the previous three steps 32, 34 and 36. After the super-finishing, the pinion gear 12 and the ring gear 14 may have a mirror-finish.

The super-finished pinion gear teeth 16 and the ring gear teeth 18 have an average centerline roughness of 4-7 microinches. The smooth surface on the pinion gear teeth 16 and on the ring gear teeth 18 decreases the coefficient of friction when the pinion gear teeth 16 are driving the ring gear teeth 18. The decreased coefficient of friction can lead to an increase in fuel efficiency of about 0.5%. Additionally, after the super-finish has been applied, the gear set 10 does not require a break-in coating before being used in a vehicle.

An alternative method for applying the super-finish is disclosed in U.S. Patent Application publication No. 2002/0106978 to Michaud et al., the disclosure of which is hereby incorporated by reference.

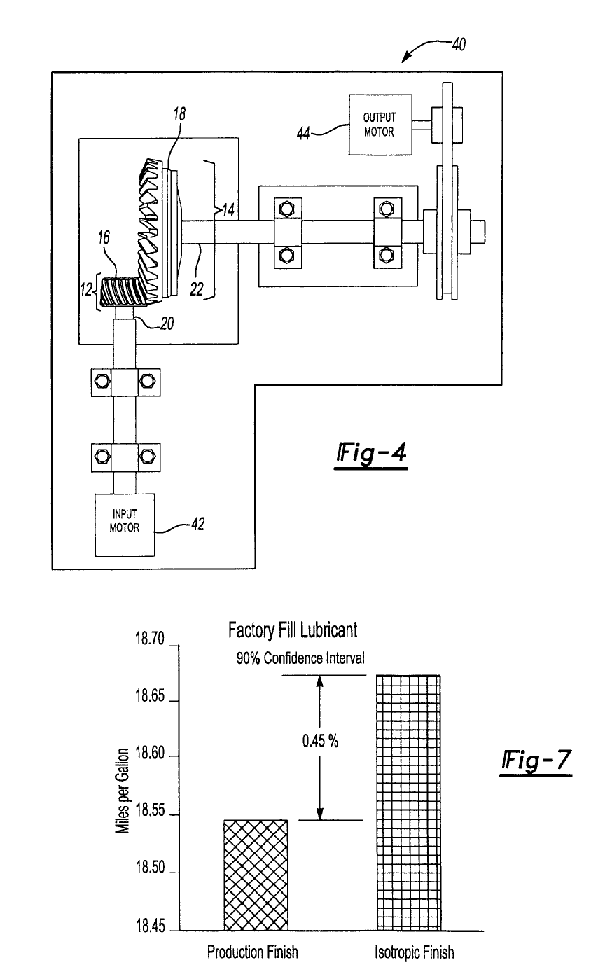

Referring now to FIG. 4, a test fixture 40 is shown that was used to test the efficiency of the rear axle gear set 10. The pinion gear 12 was connected to an input motor 42, and the ring gear 14 was connected to an output motor 44. A lubricant used during normal vehicle operation was applied to the gear set. To test the gear set 10, the input motor 42 drove the pinion gear 12 at a certain torque. The output motor 44 absorbed the energy transmitted through the gear set 10 and was controlled to provide a value representative of the output torque. The output torque was compared against a calculated input torque (knowing the gear ratio) to determine efficiency. The lubricant temperature was also monitored.

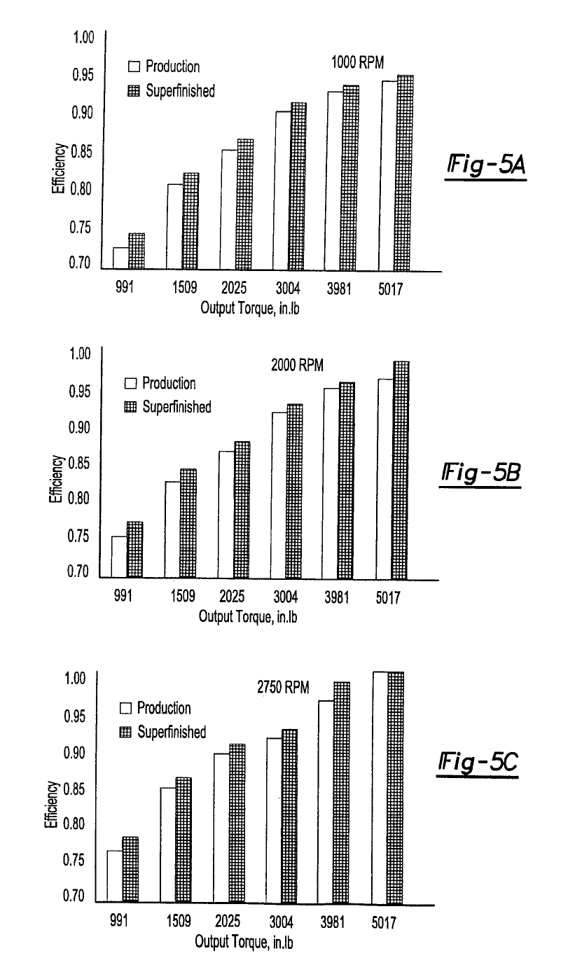

Referring now to FIGS. 5a-c, a set of graphs showing the different efficiencies obtained with a production finished rear axle gear set and a super-finished rear axle gear set is shown. The efficiency for the super-finished gear set is uniformly higher than the efficiency for the production finished rear axle gear set. The efficiency is especially higher for the super-finished gear set at low output torques where it is generally difficult to obtain high rear axle efficiencies.

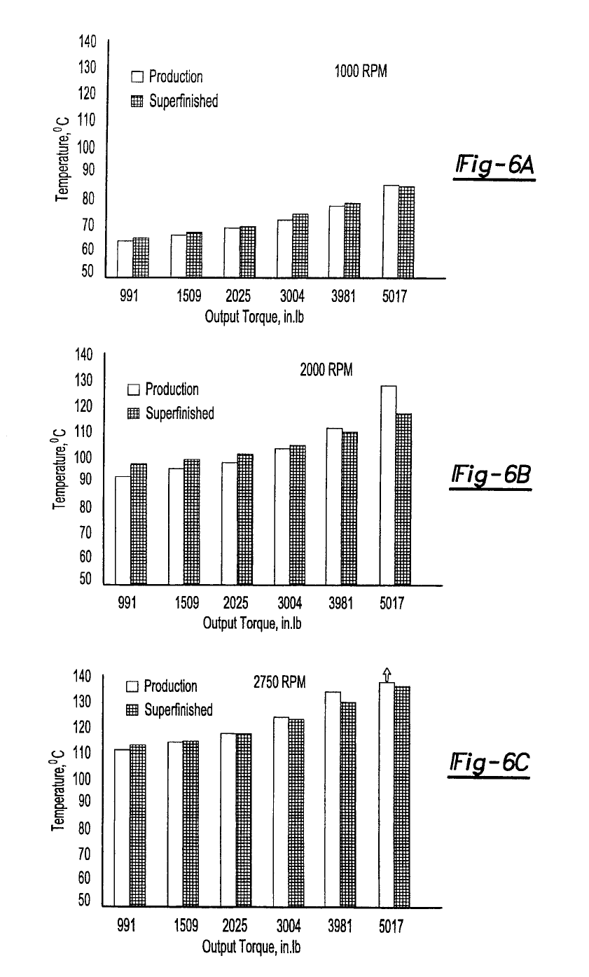

Referring now to FIGS. 6a-c, a set of graphs is shown illustrating the different lubricant temperatures in a production finished rear axle gear set and a super-finished rear axle gear set. For the most part, the temperatures are the same between the two finishes. However, at high output torques where it is generally difficult to maintain a low lubricant temperature, the lubricant temperature is lower for the super-finished gear set than it is for the production finished gear set.

Referring now to FIG. 7, a graph illustrating the difference in fuel efficiency between a production and super-finished rear axle gear set is shown using a chassis roll dynamometer test. The super-finish provides about 0.13 more miles per gallon, which translates to a 0.45% gas mileage improvement in FTP metro/highway cycles.

While the best mode for carrying out the invention has been described in detail, those familiar with the art to which this invention relates will recognize various alternative designs and embodiments for practicing the invention as defined by the following claims.

1. A gear set for a vehicle having a drive shaft and a rear axle, comprising:
a pinion gear connected to the drive shaft, the pinion gear having a plurality of teeth;
a ring gear connected to the rear axle and having a plurality of teeth that are engaged by the teeth of the pinion gear;
the teeth of the ring gear and the teeth of the pinion gear are super-finished to a low surface roughness; and
wherein the super-finished teeth of the pinion gear drive the super-finished teeth of the ring gear with a higher axle efficiency.

2. The gear set of a vehicle of claim 1 wherein the super-finished surface provides a mirror finish.

3. The gear set for a vehicle of claim 1 wherein the super-finished surfaces improve the fuel efficiency of the vehicle.

4. The gear set for a vehicle of claim 1 wherein the super-finished ring gear and pinion gear are not provided with a break-in coating before being used in the vehicle.

5. A gear set for a vehicle having a drive shaft and a rear axle, comprising:
a pinion gear connected to the drive shaft, the pinion gear having a plurality of teeth;
a ring gear connected to the rear axle and having a plurality of teeth that are complementary to the teeth of the pinion gear;
the teeth of the ring gear and the teeth of the pinion gear having a super-finished surface, wherein the super-finished surface is provided by placing the ring gear and pinion gear in a vessel containing an acid solution and ceramic pebbles, wherein the acid solution creates a film on the ring gear and pinion gear, and the ceramic pebbles remove the film, providing a surface finish having an average roughness of 4-7 microinches; and
wherein the super-finished teeth of the ring gear are driven by the super-finished teeth of the pinion gear and wherein increased power transmission efficiency is realized due to a reduction of the coefficient of friction between the ring gear and the pinion gear.

6. A gear set for a vehicle having a drive shaft and a rear axle, the gear set having a pinion gear connected to the drive shaft, the pinion gear having a plurality of teeth, and a ring gear connected to the rear axle, the ring gear having a plurality of teeth that mesh with the teeth of the pinion gear, and the teeth of the ring gear and the teeth of pinion gear have a super-finish provided by the method of:
placing the pinion gear and the ring gear in a first vessel containing an acidic solution and ceramic pebbles;
etching of the surface of the pinion gear and the ring gear by the acidic solution, the acidic solution further leaving a film on the ring gear and the pinion gear;
using the ceramic pebbles to remove the film from the pinion gear and the ring gear;
placing the ring gear and the pinion gear in a second vessel containing a solution which neutralizes the acidic solution in the first vessel; and
wherein the super-finished teeth of the ring gear are driven by the super-finished teeth of the pinion gear and wherein a reduced coefficient of friction between the ring gear and the pinion gear leads to improved rear axle efficiency.
